(19) United States
(12) Patent Application Publication
(10) Pub. No.: US 2007/0297273 A1
(43) Pub. Date: Dec. 27, 2007

(54) DRIVE SYSTEM FOR A PLASTICIZING UNIT OF AN INJECTION MOLDING MACHINE

(75) Inventor: OTTO URBANEK, Munchen (DE)

Correspondence Address: Henry M. Feiereisen;Henry M. Feiereisen, LLC, Suite 4714, 350 Fifth Avenue, New York, NY, 10118, US

(73) Assignee: MANNESMANN PLASTICS MACHINERY GMBH, Munchen (DE)

(21) Appl. No.: 11/854,190

(22) Filed: Sep. 12, 2007

Related U.S. Application Data
(63) Continuation of application No. PCT/EP2006/050924, filed on Feb. 14, 2006.

(30) Foreign Application Priority Data
Mar. 17, 2005 (DE) 10 2005 012 337.6

(51) Int. Cl. B28C 1/16; B29C 45/00

(52) U.S. Cl. 366/78; 425/587; 399/79

(57) ABSTRACT

A drive system for a plasticizing unit of an injection molding machine includes at least one drive motor which is operatively coupled to a plasticizing screw of the plasticizing unit for providing power for axial movement and rotation of the plasticizing screw in a plasticizing cylinder. A spindle-nut assembly is provided for converting the power of the drive motor to cause a movement of the plasticizing screw in an axial direction. Arranged between the drive motor and the plasticizing screw is a torque transfer case which may be constructed in the form of an epicyclic gear system which has an input side coupled to the drive motor and an output side coupled to the plasticizing screw.

### CROSS-REFERENCES TO RELATED APPLICATIONS

This application is a continuation of prior filed copending PCT International application no. PCT/EP20061050924, filed Feb. 14, 2006, which designated the United States and has been published but not in English as International Publication No. WO 2006/097394 and on which priority is claimed under 35 U.S.C. §120, and which claims the priority of German Patent Application, Serial No. 102005012337.6, filed Mar. 17, 2005, pursuant to 35 U.S.C. 119(a)-(d), the content of which is incorporated herein by reference in its entirety as if fully set forth herein.

### BACKGROUND OF THE INVENTION

The present invention relates, in general, to a drive system for plasticizing unit of an injection molding machine.

Nothing in the following discussion of the state of the art is to be construed as an admission of prior art.

A plasticizing unit of an injection molding machine typically includes a plasticizing screw which is received in a plasticizing cylinder for rotation and axial movement. As it rotates, the plasticizing unit converts plastic material into plastic melt while subject to shearing energy and moves forward. As plastic melt accumulates at the tip end of the plasticizing screw, the plasticizing screw is forced to move backwards. When enough plastic melt has accumulated, the plasticizing screw is moved forwards for injecting plastic melt into a cavity of a mold. The movement of the plasticizing screw is normally realized by a rotary drive, e.g. a hydraulic motor, and an axial drive, e.g. a piston and cylinder assembly. The use of two electric motors has also been proposed, e.g. in U.S. Pat. No. 5,540,495 to Pickel, in order to rotate and axially move the plasticizing screw. Combinations of electric and hydraulic drives, so-called hybrids, have also been proposed.

It would be desirable and advantageous to provide an improved drive system to obviate prior art shortcomings.

### SUMMARY OF THE INVENTION

According to one aspect of the present invention, a drive system for a plasticizing unit of an injection molding machine includes at least one drive motor operatively coupled to a plasticizing screw of the plasticizing unit for providing power for axial movement and rotation of the plasticizing screw in a plasticizing cylinder, a spindle-nut assembly converting the power of the drive motor to cause a movement of the plasticizing screw in an axial direction, and a torque transfer case arranged between the drive motor and the plasticizing screw.

According to another feature of the present invention, the torque transfer case may be constructed in the form of an epicyclic or planetary gear system having at least one sun wheel and at least one planet wheel, with the epicyclic gear system having an input side coupled to the drive motor and an output side coupled to the plasticizing screw. An epicyclic gear system having planet wheels mounted on a planet carrier has, depending on the respective construction, a number of degrees of freedom which can be limited by controlling the individually revolving components. As a result, different rotation movements can be realized and a torque distribution can be effected. The plasticizing screw can thus be moved axially forward as well as rotated, using a single drive motor only. Various constructions are possible. For example, the spindle of the spindle-nut assembly may be securely connected to the drive motor, e.g. an electric motor or hydraulic motor, whereas the spindle nut of the spindle-nut assembly is formed by the sun wheel of the epicyclic gear system. Suitably, the epicyclic gear system may also have a ring gear which may be disposed in coaxial relationship to the sun wheel and securely fixed to the plasticizing screw. Of course, the plasticizing screw may also be coupled to the planet carrier for the planet wheels.

According to another feature of the present invention, the drive motor may have a rotor which is securely fixed to the spindle of the spindle-nut assembly, with the sun wheel of the epicyclic gear system constituting the spindle nut. As alternative, the spindle nut may be formed integral with the rotor, with the spindle securely fixed to the sun wheel of the epicyclic gear system. Kinematically reversed options are also possible. For example, the drive motor may be firmly connected to the ring gear or planet carrier, whereas the plasticizing screw may be securely coupled to the spindle which runs in a spindle nut that forms the sun wheel. This construction, too, provides rotary and axial movements of the plasticizing screw.

According to another feature of the present invention, a device may be provided for controlling a rotational speed of individual components, e.g. ring gear. The device may hereby be implemented as a brake unit for the ring gear, planet carrier, planet wheels, or central sun wheel. As an alternative, the device may also be constructed as a drive unit which assumes braking function at the same time. Thus, an electric motor may be used which is able to not only decelerate a gear system component but also to accelerate this gear system component. Such accelerations basically allow also a dynamic enhancement of a particular process (melting, injecting). There are many ways of realizing deceleration and acceleration of components, only several of which will be detailed here. However, other embodiments which generally follow the concepts outlined here are considered to be covered by this disclosure. For example, components of the epicyclic gear system may be decelerated or accelerated absolutely, i.e. in relation to a fixed casing. It is also conceivable to brake or accelerate various gear system components in relation to one another. Instead of the use of electric motors, it is, of course, also possible to employ other drive units, such as hydraulic motor which operates also as hydraulic pump, for influencing the rotation of the respective gear system component.

According to another aspect of the present invention, a plasticizing unit includes a plasticizing cylinder, a plasticizing screw accommodated in the plasticizing cylinder, at least one drive motor operatively coupled to the plasticizing screw for providing power for axial movement and rotation of the plasticizing screw in the plasticizing cylinder, a spindle-nut assembly converting the power of the drive motor to cause a movement of the plasticizing screw in an axial direction, and a torque transfer case arranged between the drive motor and the plasticizing screw.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a first basic construction of a drive system according to the present invention;

FIG. 2 is a schematic illustration of a variant of the drive system of FIG. 1;

FIG. 3 is a schematic illustration of another variant of the drive system of FIG. 1;

FIG. 4 is a schematic illustration of a second basic construction of a drive system according to the present invention;

FIG. 5 is a schematic illustration of a third basic construction of a drive system according to the present invention;

FIG. 6 is a schematic illustration of a fourth basic construction of a drive system according to the present invention; and

FIG. 7 is a detailed illustration of a basic configuration of a spindle-nut assembly incorporated in a drive system according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Common to all constructions, as illustrated in the figures is the arrangement of a spindle-nut assembly, as shown in FIG. 7, in combination with a torque transfer case, between a main drive and a plasticizing screw. The term “transfer case” as used herein refers to a gear system having at least one wheel which rotates about its own axis as well as about a center axis. There are innumerable ways to implement a transfer case, several of which will be detailed here. However, other embodiments which generally follow the concepts outlined here are considered to be covered by this disclosure. A simple transfer case may be realized in the form of an epicyclic gear system having a central wheel, also called sun wheel, at least one planet wheel, a planet carrier for support of the planet wheel(s), and an outer ring gear. Various motion and torque distributions possibilities with defined number of degrees of freedom can be implemented in dependence on which member operates as mount, drive, or output. Simple gear systems with three revolving members have a degree of freedom of 2.

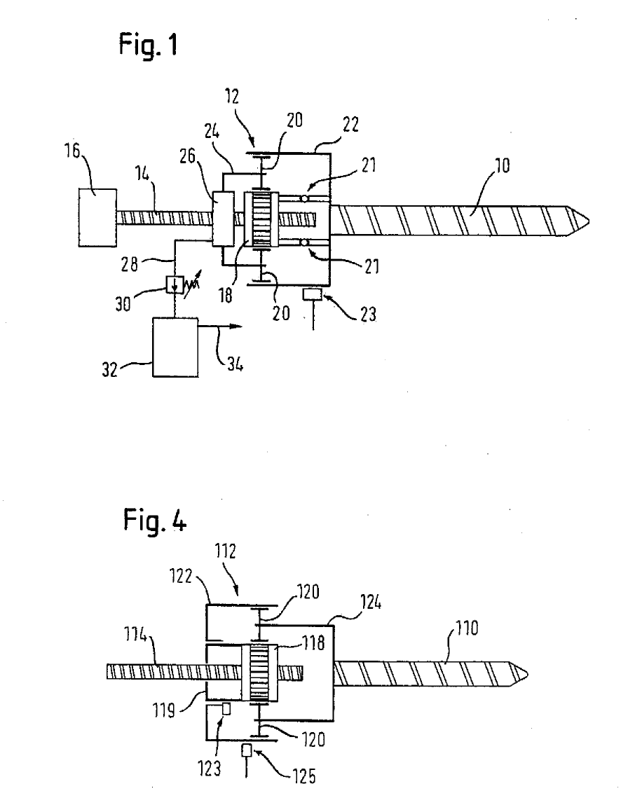

Turning now to the drawing, and in particular to FIG. 1, there is shown a schematic illustration of a first basic construction of a drive system according to the present invention for application in a plasticizing unit of an injection molding machine. The plasticizing unit has a plasticizing screw 10 which is received in an unillustrated plasticizing cylinder and driven for rotation as well as axial movement by a single high-torque electric motor 16 as main drive. The electric motor 16 has a rotor (not shown) which is securely fixed to a coaxial spindle 14, which forms part of a spindle-nut assembly and is immobile in axial direction but allowed to rotate. Another part of the spindle-nut assembly involves a spindle nut 18 which is mounted onto the spindle 14 for axial movement, as the spindle 14 rotates in relation to the spindle nut 18.

The spindle nut 18 forms the central sun wheel of a epicyclic gear system, generally designated by reference numeral 12 and further including two planet wheels 20, constructed as cylindrical gears. Arranged in coaxial relationship radially outside to the spindle nut 18 is a ring gear 22 having internal teeth meshing with the planet wheels 20.

The ring gear 22 is firmly coupled with the plasticizing screw 10. The planet wheels 20 are supported on a revolving planet carrier 24 which rotates about the same axis as the spindle nut 18 and the ring gear 22. The planet carrier 24 is operatively connected to a hydraulic pump 26 such that the hydraulic pump 26 rotates, as the planet carrier 24 revolves. The hydraulic pump 26 is connected via a hydraulic conduit 28 and an adjustable proportional valve 30 to a hydraulic accumulator 32 from which a supply conduit 34 leads away.

The drive system, shown in FIG. 1, further includes an actuatable brake unit 23 which is so configured and arranged as to be able to interact with the ring gear 22 for braking the ring gear 22. The brake unit 23 may be constructed in a simple manner with brake shoes (not shown) which effect a desired deceleration of the ring gear 22 when actuated.

In order to ensure an axial support between the plasticizing screw 10 and the spindle nut 18, a ball bearing 21, shown only schematically in FIG. 1, is provided between the plasticizing screw 10 and the spindle nut 18. For the sake of simplicity, the depiction of a ball bearing has been omitted in FIGS. 4 to 6, which will be described hereinbelow.

The drive system of FIG. 1 operates as follows: The electric motor 16 operates as main drive to provide the power for effecting the axial advance of the plasticizing screw 10 for the injection phase as well as the rotation of the plasticizing screw 10 for the metering phase. When the injection phase is to be carried out, the ring gear 22 is at a standstill as a result of the operation of the brake unit 23. At the same time, the proportional valve 30 is operated to significantly increase the back pressure in the hydraulic conduit 28. As a consequence, the hydraulic pump 26 has to operate in opposition to the back pressure, causing the planet carrier 24 for the planet wheels 20 to ultimately cease to rotate. When, neither the planet carrier 24 nor the ring gear 22 rotates, the planet wheels 20 are also fixed in place, causing also the spindle nut 18 (sun wheel) to stop rotation. As the electric motor 16 continues to drive the spindle 14, the interaction between spindle 14 and spindle nut 18 causes the spindle nut 18 to move in axial direction forwards along the spindle 14, upon appropriate rotation of the electric motor 16. The forward movement by the spindle nut 18 is translated via the ball bearing 21 to a forward movement by the plasticizing screw 10 within the plasticizing cylinder for executing the injection step by injecting melt that has accumulated during the metering phase at the tip end of the plasticizing screw 10 into a cavity of an adjacent mold (not shown).

When the injection phase is over, the brake unit 23 is released and the back pressure in the hydraulic conduit 28 is decreased. Application of a certain torque is required to be able to rotate the plasticizing screw 10 because of friction between the plasticizing screw 10 in the plasticizing cylinder. When the plasticizing screw 10 does not rotate and the planet carrier 24 rotates only slightly, the spindle nut 18 would again move forwards until a certain pressure builds up that bars any further advance of the spindle nut 18. At that point, i.e., when the spindle nut 18 can no longer move forward, the spindle nut 18 is caused to spontaneously rotate. This rotation by the spindle nut 18 is transferred via the planet wheels 20 onto the plasticizing screw 10 which thus rotates to effect a plasticizing of incoming plastic material, with produced plastic melt being advanced and accumulating at the tip end of the plasticizing screw 10. As plastic melt accumulates at the tip end, pressure builds up, causing the plasticizing screw 10 to move backwards, resulting in a rotational movement which is transmitted via the planet wheels 20 to the ring gear 22. The retraction of the plasticizing screw 10 as a result of back pressure that builds up as plastic melt accumulates at the tip end of the plasticizing screw 10 thus causes the plasticizing screw 10 to accelerate rotation. The pressure at the tip end of the plasticizing screw 10 can hereby be adjusted until equilibrium is realized between the forwardly pushing spindle nut 18, the rotation of the plasticizing screw 10 with respective friction, and the back pressure. These various rotation values can be controlled by the back pressure in the hydraulic conduit 28 with the assistance of the proportional valve 30 and the brake unit 23. Of course, the spindle-nut assembly, in particular screw lead and screw configuration, should be selected such that the spindle nut can be moved backwards when a certain back pressure has been reached.

When the back pressure in the hydraulic conduit 28 decreases to zero, the hydraulic pump 26 operates in the absence of any resistance and thus could freely rotate jointly with the planet carrier 24. As a result, the planet wheels 20 can loosely revolve about the spindle nut 18 (sun wheel). Thus, when the spindle 14 is driven by the electric motor 16, the spindle nut 18 only would rotate while the planet wheels 20 revolve about the spindle nut 18. The revolving speed of the planet carrier 24 is reduced in response to an increase of the back pressure in the hydraulic conduit 28, so that the rotation of the spindle nut 18 causes the ring gear 22 and thus the plasticizing screw 10 to rotate.

Thence, the plasticizing screw 10 can thus be moved axially as well as rotated by a single electric motor 16.

The hydraulic accumulator 32 is used to utilize the pressure that builds up therein for other systems. For example, the pressure can be used for forcing the plasticizing unit against a mold, using one or more piston and cylinder units. Another example involves the utilization of this pressure for operating core pulling elements in a clamping unit.

The drive can be controlled in response to a measurement of the back pressure and respective operation of the proportional valve 30.

Of course, the configuration of the drive system of FIG. 1 is shown by way of example only, and other configurations which generally follow the concepts outlined here are considered to be covered by this disclosure. For example, the main drive 16 may be implemented in the form of a high-torque motor having a rotor which can be constructed as spindle nut or is connected integrally with a spindle nut. In this case, the spindle is securely fixed to the sun wheel. The axial relative movement between spindle and spindle nut thus takes place radially inside the main drive. This construction requires however acceleration and deceleration of a greater rotation mass.

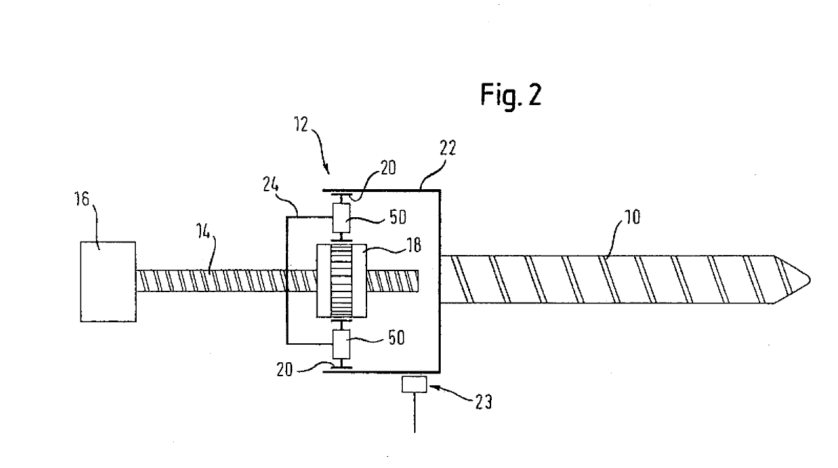

Referring now to FIG. 2, there is shown a schematic illustration of a variant of the drive system of FIG. 1, with the difference residing in the manner of influencing the rotation speed of planet wheel 24 and ring gear 22. Parts corresponding with those in FIG. 1 are denoted by identical reference numerals and not explained again. The description below will center on the differences between the embodiments. In this embodiment, provision is made for the additional use of small auxiliary electric motors 50 which are arranged radially within the planet wheels 20 for effecting a relatively high torque. Each electric motor 50 includes a stator (not shown), which is supported on the planet carrier 24, and a rotor which is coupled to an associated planet wheel 20. In this way, the rotation of each planet wheel 20 can be influenced. As in FIG. 1, the rotation of the ring gear 22 may also be controlled by the brake unit 23. The use of auxiliary motors thus enhances the versatility of the overall drive system.

The drive system of FIG. 2 operates as follows: During the injection phase, the ring gear 22 is decelerated and the planet wheels 20 are also effectively brought to a stop. As the ring gear 22 and the planet wheels 20 cease to rotate, the spindle nut 18 can also no longer rotate, causing the spindle nut 18 to move axially, as the main motor 16 continues to run. Releasing the brake unit 23 enables a rotation of the ring gear 22, with the rotational speed thereof depending on the rotational speed of the planet wheels 20. The rotational speed of the planet wheels 20 can, however, be influenced by the electric motors 50. Suitably, the electric motors 50 serve at the same time as generators to produce energy which may, optionally, stored for use in the drive system.

The use of auxiliary drives, such as electric motors 20, allows a rotation of the spindle nut in opposite direction to the rotation of the plasticizing screw, when the ring gear is at a standstill. As a result, the system dynamics are enhanced. In particular, injection speeds can be increased and the time can be reduced until a maximum speed is reached. Such an enhancement of system dynamics can be realized when auxiliary drives are used to rotate the spindle nut in opposition to the rotation of the plasticizing screw.

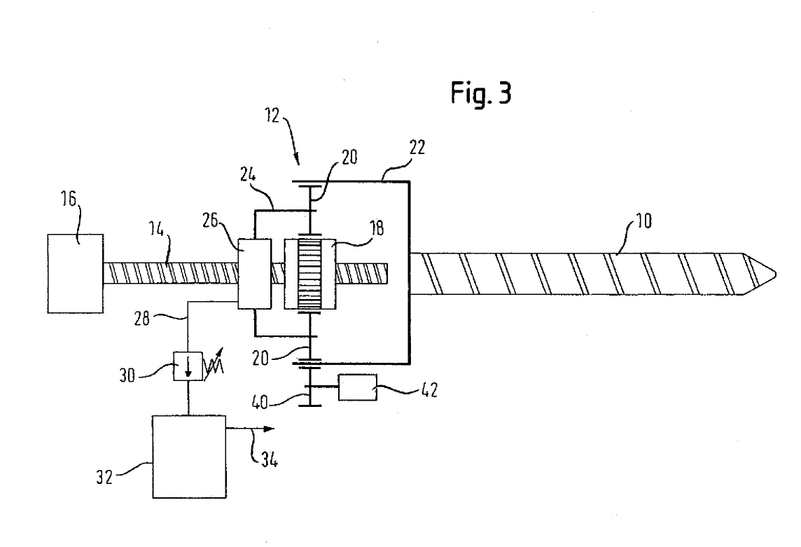

FIG. 3 shows a schematic illustration of yet another variant of the drive system of FIG. 1. Parts corresponding with those in FIG. 1 are denoted by identical reference numerals and not explained again. The description below will center on the differences between the embodiments. In this embodiment, the brake unit is replaced by a combination of a pinion 40 and an auxiliary electric motor 42. The pinion 40 meshes hereby with a toothed outer surface of the ring gear 22 to thereby influence the revolving speed of the ring gear 22. This construction also allows a drive of the ring gear 22.

Turning now to FIG. 4, there is shown a schematic illustration of a second basic construction of a drive system according to the present invention. In describing FIG. 4, parts corresponding with those in FIG. 1 will be identified by corresponding reference numerals, each increased by “100”. FIG. 4 shows a plasticizing screw 110 which is connected to a planet carrier 124 for support of the planet wheels 120 of an epicyclic gear system 112. As a result, the ring gear 122 can be brought to a halt in relation to the central sun wheel (spindle nut 118) by the brake unit 123. The brake unit 123 includes hereby a brake drum 119 which is attached to the central sun wheel 118. As the spindle 114 is operated by the main drive (not shown here) and the ring gear 122 is at a standstill in relation to the sun wheel 118 by means of the brake unit 123, the planet wheels 120 are prevented from rotating, causing the planet carrier 124 to follow the rotational movements by the ring gear 122 and the central sun wheel 118.

Placed on the outer circumference of the ring gear 122 is a further brake unit 125 which, when actuated, stops the ring gear 122, thereby necessarily moving the plasticizing screw 110 axially forwards as the spindle 114 rotates in relation to the spindle nut 118. When the brake unit 125 is released, the ring gear 122 is able to rotate, causing a rotation of the planet carrier 124, when the brake unit 123 is actuated. Again, the back pressure of plastic melt adjusts at the tip end of the plasticizing screw 110 until an equilibrium of forces has been established. The rotational speed of the plasticizing screw 110 can be controlled by varying the extent of brake release.

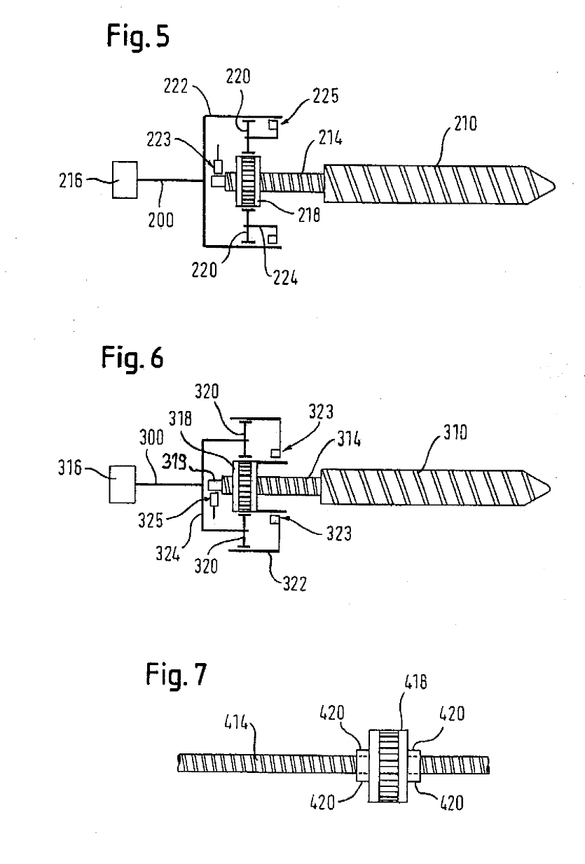

FIG. 5 shows a schematic illustration of a third basic construction of a drive system according to the present invention. In describing FIG. 5, parts corresponding with those in FIG. 1 will be identified by corresponding reference numerals, each increased by “200”. The description below will center on the differences between the embodiments. In this embodiment, provision is made for a spindle 214 which is firmly connected in coaxial relationship to the plasticizing screw 210. The spindle 214 interacts again with a spindle nut 218 which represents the sun wheel of an epicyclic gear system. Planet wheels 220 are arranged radially outside of the spindle nut 218 and supported in a planet carrier 224 which is able to rotate about the axis of the spindle nut 218 and can be brought to a halt in relation to a ring gear 222 by a brake unit 225. The ring gear 222 has a shaft 200 for rigid connection to a main drive 216, e.g. an electric motor.

At operation, the ring gear 222 is driven by means of the electric motor 216 via the shaft 200. When the brake unit 225 is actuated, the planet carrier 224 is brought to a halt relative to the ring gear 222 so that the planet wheels 220 are also unable to rotate. As a result, the spindle nut 218 rotates at a same angular velocity as the ring gear 222. Stoppage of the spindle 214 through actuation of the brake unit 223 causes the plasticizing screw 210 to move axially. During the metering phase, the brake unit 223 s slightly released so that the plasticizing screw 210 is able to rotate, whereby the rotational speed of the plasticizing screw 210 can be adjusted by how firmly the brake units 223, 225 are applied.

Of course, the brake units 223, 225 may be substituted by active drives which provide a driving force as well as apply a braking action. When using these drives as generators at the same time, energy can be recovered for feedback into the system.

Referring now to FIG. 6, there is shown a schematic illustration of a fourth basic construction of a drive system according to the present invention. In describing FIG. 6, parts corresponding with those in FIG. 1 will be identified by corresponding reference numerals, each increased by “300”. The description below will center on the differences between the embodiments. In this embodiment, the drive motor 316 is coupled via the shaft 300 with the planet carrier 324 for the planet wheels 320. The ring gear 332 can hereby be brought to a halt in relation to the spindle nut 318 which again represents the sun wheel, by using a brake unit 323 which has a brake drum formed integrally with the spindle nut 318. A pin 319 projects out from the rear end of the spindle 314 for interaction with a brake unit 325. The plasticizing screw 310 can be moved axially and rotated by a combining the operation of the brake units 323, 325. For example, when the brake unit 323 is applied to bring the ring gear 322 a halt in relation to the spindle nut 318, the planet wheels 320 are stopped at the same time. In other words, the spindle nut 318 rotates at a same rotational speed as the planet carrier 324. Stoppage of the spindle 314 with the brake unit 325 causes the plasticizing screw 310 to now move axially forward. By suitably releasing the brake units 323, 325 to apply a certain braking force, it becomes possible for the plasticizing screw 310 to rotate again, and an equilibrium can be established between the reaction torque in the plasticizing cylinder, caused through friction during melt production, melt back pressure, and constructive measures.

FIG. 7 shows a detailed illustration of a basic configuration of a spindle-nut assembly incorporated in a drive system according to the present invention. The spindle-nut assembly includes a spindle 414 and a spindle nut 418 mounted on the spindle 414. A relative movement between the spindle 414 and the spindle nut 418 can be influenced by two sleeve-like brake units 420 which are arranged to the sides of the spindle nut 418 and operate with a clamping action to thereby decelerate the spindle 414 in relation to the spindle nut 418. Of course, a brake unit can also easily be realized by using brake shoes. It is also conceivable to use any mechanism by which the rotational speed of individual gear system components can be influenced. For example, electric motors, as shown in FIGS. 2, 3 can be used which also operate as generators. Also possible is the use of hydraulic motors or pumps which operate in opposition to an adjustable back pressure during pumping operation. Another option involves the use of eddy current brakes. Thus, any mechanism or device can be used so long as the rotational speed of individual gear system components can be influenced either absolutely or in relation to other gear system components in order to control a movement pattern.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A drive system for a plasticizing unit of an injection molding machine, comprising:
at least one drive motor operatively coupled to a plasticizing screw of the plasticizing unit for providing power for axial movement and rotation of the plasticizing screw in a plasticizing cylinder;
a spindle-nut assembly converting the power of the drive motor to cause a movement of the plasticizing screw in an axial direction; and
a torque transfer case arranged between the drive motor and the plasticizing screw.

2. The drive system of claim 1, wherein the torque transfer case is constructed in the form of an epicyclic gear system having at least one sun wheel and at least one planet wheel, said epicyclic gear system having an input side coupled to the drive motor and an output side coupled to the plasticizing screw.

3. The drive system of claim 2, wherein the epicyclic gear system has a ring gear in coaxial relationship to the sun wheel.

4. The drive system of claim 2, wherein the drive motor has a rotor which is securely coupled to a spindle of the spindle-nut assembly, said sun wheel of the epicyclic gear system configured as a spindle nut of the spindle-nut assembly.

5. The drive system of claim 2, wherein the drive motor has a rotor which is coupled to a spindle nut of the spindle-nut assembly, said sun wheel of the epicyclic gear system being securely fixed to a spindle of the spindle-nut assembly.

6. The drive system of claim 3, wherein the plasticizing screw is firmly secured to the ring gear.

7. The drive system of claim 2, wherein the epicyclic gear system includes a plurality of said planet wheel, and further comprising a device for controlling an orbiting speed of the planet wheels.

8. The drive system of claim 7, wherein the device is constructed in the form of a hydraulic pump or electric motor operating in opposition to a back pressure.

9. The drive system of claim 8, further comprising a proportional valve for adjusting the back pressure.

10. The drive system of claim 2, wherein the epicyclic gear system includes a plurality of said planet wheel, and further comprising a device for controlling a rotational speed of the planet wheels.

11. The drive system of claim 10, wherein the device is a member selected from the group consisting of hydraulic drive, pneumatic drive, and electric drive.

12. The drive system of claim 11, wherein the electric drive is an electric motor.

13. The drive system of claim 8, further comprising a hydraulic accumulator charged by the hydraulic pump.

14. The drive system of claim 3, further comprising a device for controlling a rotational speed of the ring gear.

15. The drive system of claim 14, wherein the device is a brake unit for decelerating the ring gear.

16. The drive system of claim 13, wherein the device is a drive unit for selectively decelerating or accelerating the ring gear.

17. The drive system of claim 2, wherein the epicyclic gear system has a planet carrier for support of the at least one planet wheel, said planet carrier being coupled to the plasticizing screw.

18. The drive system of claim 3, further comprising a device selected from the group consisting of drive unit and brake unit for controlling an orbiting speed of the ring gear.

19. The drive system of claim 3, further comprising a device for controlling a relative movement between the ring gear and the sun wheel.

20. The drive system of claim 19, wherein the device includes a hydraulic pump or electric motor operating in opposition to a back pressure.

21. The drive system of claim 20, further comprising a proportional valve for adjusting the back pressure.

22. The drive system of claim 3, wherein the drive motor is securely fixed to the ring gear, said sun wheel of the epicyclic gear system constituting a spindle nut of the spindle-nut assembly, said spindle-nut assembly having a spindle secured fixed to the plasticizing screw.

23. The drive system of claim 2, wherein the epicyclic gear system has a planet carrier for support of the at least one planet wheel, said planet carrier being securely coupled to the drive motor, said sun wheel of the epicyclic gear system constituting a spindle nut of the spindle-nut assembly, said spindle-nut assembly having a spindle secured fixed to the plasticizing screw.

24. The drive system of claim 1, further comprising a device for controlling a relative rotation between a spindle of the spindle-nut assembly and a spindle nut of the spindle-nut assembly.

25. A plasticizing unit, comprising:
a plasticizing cylinder;
a plasticizing screw accommodated in the plasticizing cylinder;
at least one drive motor operatively coupled to the plasticizing screw for providing power for axial movement and rotation of the plasticizing screw in the plasticizing cylinder;
a spindle-nut assembly converting the power of the drive motor to cause a movement of the plasticizing screw in an axial direction; and
a torque transfer case arranged between the drive motor and the plasticizing screw.
